(19) United States
(12) Patent Application Publication
(10) Pub. No.: US 2015/0339729 A1
(43) Pub. Date: Nov. 26, 2015

(54) ONLINE ADVERTISING CAMPAIGN CONTROLLER TO ORCHESTRATE ALLOCATION OF ADS

(71) Applicant: Pubmatic, Inc., Redwood City, CA (US)

(72) Inventor: Prashant MAHAJAN, Pune (IN)

(21) Appl. No.: 14/282,795

(22) Filed: May 20, 2014

(51) Int. Cl. G06Q 30/02

(52) U.S. Cl. CPC G06Q 30/0275; G06Q 30/0273; G06Q 30/0277

(57) ABSTRACT

Ad segments on a Web page are filled with ads that are served by a service provider operating between a user computer and publisher on one end and multiple ad serving entities on the other. The ads include those served by publisher ad server and also real time bidding. An offline campaign controller orchestrates the allocation of guaranteed and real time bidding by monitoring performance of the direct sold campaigns and generating updates to targeting parameters of UOE ad campaign and rules for an edge server. When a direct sold campaign is on track, the updates on UOE campaign permits an ad segment to be considered for real time bidding.

### TECHNICAL FIELD OF THE INVENTION

The present invention relates generally to computer software and Internet advertising. More specifically, the invention relates to software for serving advertisements over the Internet for display on Web sites, video, and mobile.

### BACKGROUND OF THE INVENTION

The online advertising industry is growing increasingly sophisticated. As the number of display ads grows, driven mainly by more intelligent programmatic ad buying capabilities, the amount of control that publishers (entities who have an inventory of advertising space to sell) want with respect to selling this ad space inventory grew. And with it the value of the publisher's inventory rose as well. There is an increasing desire among publishers to carve out specific inventory buckets for their ad space inventory. On the advertiser side, advertisers are now increasingly particular about how much they will pay to place their ads on Web pages. Presently, prices for paying for ad space is based on fairly generic level controls, such as Web site traffic, location on Web page, visibility on page, and the like.

It would be desirable to provide publishers with greater level of control in determining which ads are served to them for display based on a variety of demographic and other categories. Overall this would also be desirable for the advertisers and entities providing services to advertisers. Advertisers would like to be able to target a specific audience and have the flexibility of paying more or less for a given ad segment depending on who will see the ad.

Additionally publishers also may like to have a combination of direct sold ad campaigns and real time bidding. Referring to FIG. 1, ads may be served from either a direct sold ad campaign (publisher ad server) or through a real time bidding (RTB) process in which an ad server receives bids from a demand side platform (DSP) or a set of DSPs. An edge server may be provided to support improved response time.

In this hybrid approach, optimization may be provided to optimize revenue for the publisher while also satisfying criteria for a direct sold campaign. In a direct sold campaign there may, for example, be a fixed price per impression of a given type (e.g., $1 per mil) and there may be a campaign goal for the number of impressions served at the guaranteed price. Thus, it is important that the direct sold campaign remain on track over the course of a campaign in order to achieve a desire guaranteed goal. Additionally, the publisher may want the option to serve additional ads via bidding in order to optimize revenue. For example, if a direct sold campaign is on track, the publisher may wish to engage in real time bidding for any “extra” impressions to increase revenue. Optimizing this combination of publisher ad server and real time bidding poses many problems.

An optimized holistic approach to serving ads by both publisher ad server and real time bidding may include various components to define the impression work flow. In one approach a Unified Optimization Engine (UOE) includes an edge server and an ad server supporting real time bidding. The publisher ad server (e.g., DART ad services, Double Click For Publishers (DFP), Open Ad Services (OAS), AdTech or any other ad-server) may send the impressions first to the UOE. The critical decision making occurs at an edge server. The edge server checks the schedule indicator (also called, OSI or On Schedule Indicator for DFP) of critical campaigns and makes a decision whether the impression should be sent to the ad server for monetization via real time bidding. The impressions are passed back to the publisher ad server (e.g., back to DART/DFP) if the applicable critical campaigns are not on track for the impression attributes.

This approach has several drawbacks. First there is a problem that that there are more hops than desired. The publisher ad server (DART/DFP) sends the impression to the real time bidding platform, even when the critical campaigns are not on track and cannot be subject to real time bidding by the ad server. This results in a double counting the impression in the publisher ad server, which impacts forecasting for the campaign. Additionally, it increases the load time because of the extra hop. Moreover, it also increases the cost of ad serving.

Therefore, what is desired is an improved technique to control the allocation of impression for guaranteed and real time bidding of ads.

### SUMMARY OF THE INVENTION

In one aspect of the preset invention, a method of serving an ad to an ad segment on a Web page being viewed by a user is described. The Web page is published by an online publisher, such as a blog site, online retail store, or media company. A user visits a Web site and HTTP is downloaded to the user's browser where it is executed to render the Web site pages. In the HTTP payload there is a script for an ad which executes. The service provider acts an entity that operates between the publisher and user computer on one end and ad serving entities. A determination is made whether to serve the ad segment from a direct sold campaign or by real time bidding. In one embodiment, an offline campaign controller monitors publisher ad server. Information indicative of whether a direct sold campaign is on track is extracted. Updates to configuration targeting parameters are determined based on whether the direct sold campaign is on track. If the direct sold campaign is on track, the updates may include updates to support optimization of revenue by real time bidding for impressions. In one embodiment, the campaign controller is an offline server component that also generates updates to rules for an offline server to determine whether to submit an impression to an ad server for real time bidding.

### BRIEF DESCRIPTION OF THE DRAWINGS

The invention and the advantages thereof may best be understood by reference to the following description taken in conjunction with the accompanying drawings in which:

FIG. 1 is a block diagram showing the entities and relationships for controlling advertising in an environment having both real time bidding and publisher ad server;

FIG. 2 is a block diagram illustrating the use of a campaign controller in accordance with an embodiment of the present invention;

FIG. 3 is a flow diagram of a process of controlling an ad campaign in accordance with one embodiment of the present invention; and

FIG. 4 is a flow diagram of a method in accordance with an embodiment of the present invention.

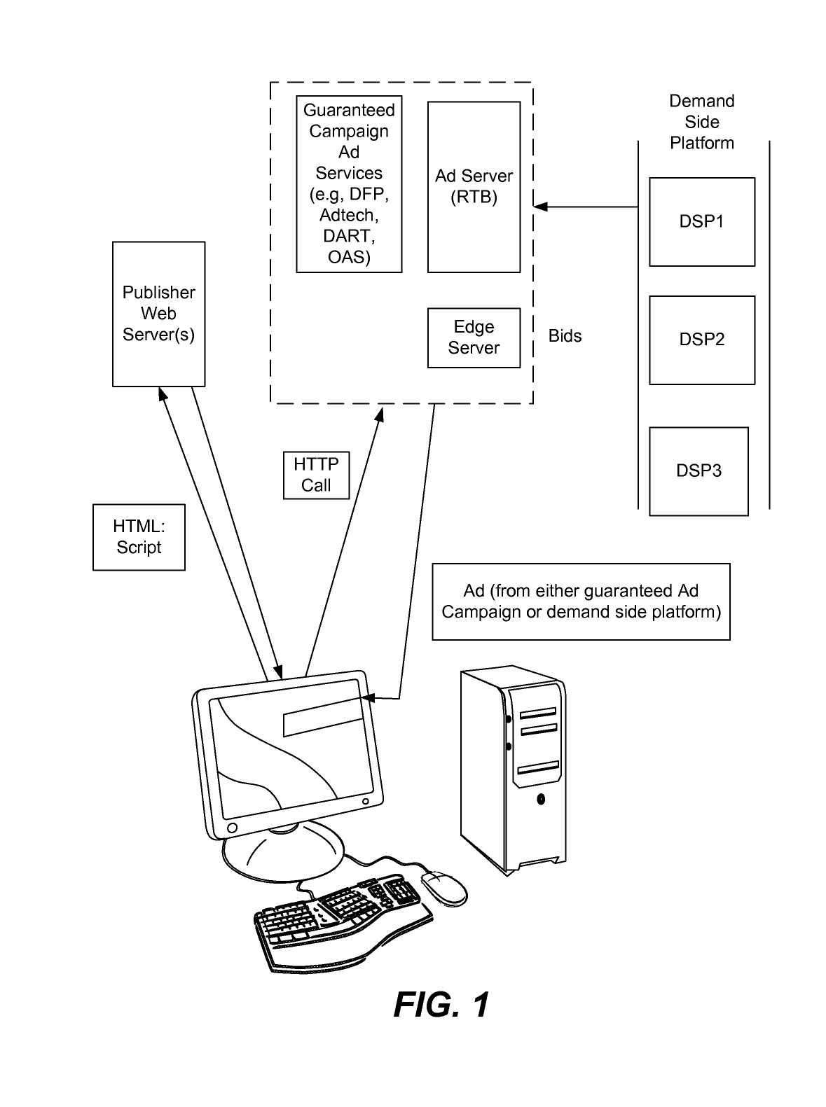

In the drawings, like reference numerals are sometimes used to designate like structural elements. It should also be appreciated that the depictions in the figures are diagrammatic and not to scale.

### DETAILED DESCRIPTION OF THE INVENTION

Methods and systems for controlling an advertising campaign are described in which orchestrate allocation of impressions between publisher ad server and real time bidding. An individual ad campaign may, for example, include a number of impressions, a budget, targeting parameters such as geographic (geo) parameters, latitude & longitude, browser parameters, operating system (OS) parameters, and devices parameters (e.g., mobile device).

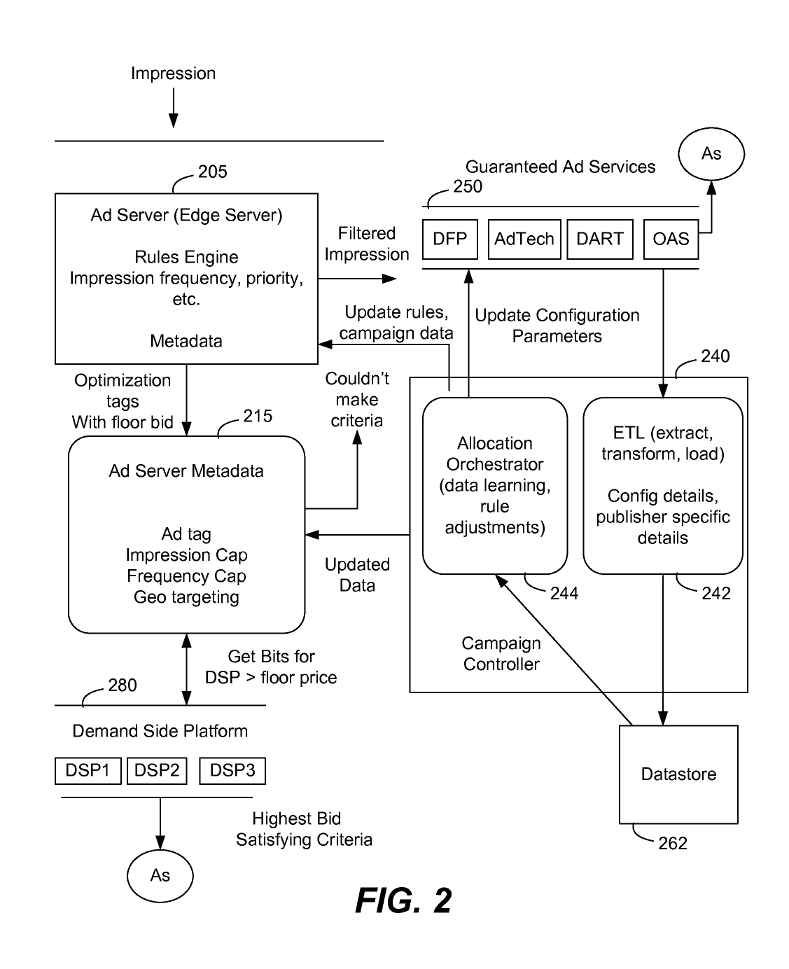

FIG. 2 illustrates a Unified Optimization Engine (UOE) system that includes an edge server 205 and an ad server 215 to handle real time bidding for a UOE campaign from a demand side platform. An edge server geographically close to the user handles the impression in order to reduce response (load) time. Publisher ad server 250 may be provided by commercial services such as DFP, Adtech, DART, OAS or any other ad-server via corresponding guaranteed ad servers. The edge server 205 decides whether to send the impression to the UOE campaign or to pass it to the publisher ad server 250.

When a user views a publisher's website, an individual web page includes tags to serve an ad segment to a corresponding location on the web page. Ad tags are provided that support a holistic option of providing either of real time bidding or a direct sold ad. That is, a publisher places UOE tags as campaigns in the publisher ad server (e.g., DART/DFP). The ad tags are issued by an ad serving company to a publisher and can be used for both UOE and direct sold ad campaigns. That is, the ad tags are recognized by guaranteed ad servers such as DART/DFP. An exemplary UOE Tag format for an optimization engine of PubMatic, Inc. is as follows:

<script type=“text/javascript”>
document.write(‘<script type=“text/javascript”
src=“http://haso.pubmatic.com/ads/DFPL/PMHimpaEngine.html?sit
e=%esid!;zone=
%epid!;pubid=34576;network=N6581;adtype=1;sname=%s;sz=%%
WIDTH%%x%
%HEIGHT%%;ord=‘+%%CACHEBUSTER%%+’”><\/script>’);
</script>

In particular, the use of real time bidding may sometimes beat a publisher's guaranteed campaign. However, in a holistic approach, the direct sold campaign must also remain on-track. A write API may be used to configure targeting information in the publisher ad server.

The edge server 205 includes a rules engine that includes rules for features such as impression frequency and priority. The edge server 205 generates optimization tags with floor bids that are passed to the ad server 215. The ad server 215 is responsible for various metadata functions and includes rules and data for ad tags, impression caps, frequency, caps, geo targeting and many other parameters. A floor price may be set for the demand side platforms (DSPs) 280, which may include ad networks bidding on ad segments. As one example, the floor price may be set to be a value greater than a guaranteed price. This floor price may be a fixed value or be determined based on historical data and demand trends to optimize revenue. For example, the highest bid above the floor price may be selected as a winning bid. However, more generally additional criteria may be imposed on the bidding process and/or other types of bidding schemes may be employed.

A campaign controller 240 is provided. The campaign controller 240 is parallel sub-system. The campaign controller is not part of the edge server, ad server, or publisher ad server. The campaign controller 240 may be implemented as a server-based sub-system. The campaign controller 240 includes an Extract, Transform and Load (ETL) unit 242 that extracts campaign configuration details, targeting parameters, publisher specific details, and other information, including an On Schedule Indicator (OSI) or other metrics regarding whether a campaign is on track in the publisher ad server 250. This information may be provided directly or indirectly to an Allocation Orchestrator unit 244. The Allocation Orchestrator unit 244 includes modules for data learning and rule adjustments. The allocation orchestrator unit 244 generates updates to configuration parameters for the publisher ad server 250. Additionally, the allocation orchestrator unit 244 generates updates to the rules and campaign data used by the edge server 205. Additional data updates may be provided by the Allocation orchestrator unit 244 to the ad server 215.

One aspect is that the allocation orchestrator unit 244 provides frequent updates to the edge server 205 and the publisher ad server 250. The updates may, for example, be provided on a periodic basis, such as daily, hourly, etc. Alternatively, the updates may be provided based on the changes to the UOE campaign in the publisher ad server 250. For example if the campaign is in a comparatively stable regime then no updates may be required. However, in this example the updates may be generated in response to detecting changes in the campaign, such as changes in the OSI. It will be understood that noise filtering, predictive, and trend analysis may also be optionally performed on the data received from the publisher ad server to optimize performance. For example historical data and statistical techniques may be employed to generate a better indicator of whether the campaign will remain on track for a select interval of time.

As illustrated, an incoming impression is received by the edge server 205 when publisher ad server chooses UOE campaign over direct sold campaigns, which makes a decision whether to send it to the ad server for real time bidding optimization or to passed back impression to the publisher ad server. One criterion that may be used is whether the direct sold campaign is on track. If the direct sold campaign is not on track, the impression is not considered for optimization via real time bidding and is thus not considered for real time bidding.

Suppose as an example that the direct sold campaign is on track and the price is $2 per mil for the direct sold campaign. In this example, the impression may be sent by the edge server to the ad sever for real time bidding with a floor price >$2. Suppose no bids are greater than the floor price. Then in this case the publisher ad server will serve the impression.

As an example suppose that the UOE campaign is initially disabled in the publisher ad server (e.g., DART/DFP). The campaign controller checks that for the geographical (geo) location of Canada, there are 20 applicable campaigns, out of which 5 are critical. The campaign controller then checks the OSI of these campaigns and determines that all of these campaigns are on track for delivery. The campaign controller then configures the geo “Canada” for the UOE campaign and enables it. As previously discussed, this may be performed using a write API to configure the targeting parameters associated with the UOE tags of the campaign. The publisher ad server (e.g., DART/DFP) starts allocating impressions from geo ‘Canada’ to the UOE campaign. At the edge server, all impressions are considered for monetization (real time bidding) as the OSI of the critical campaigns is on track.

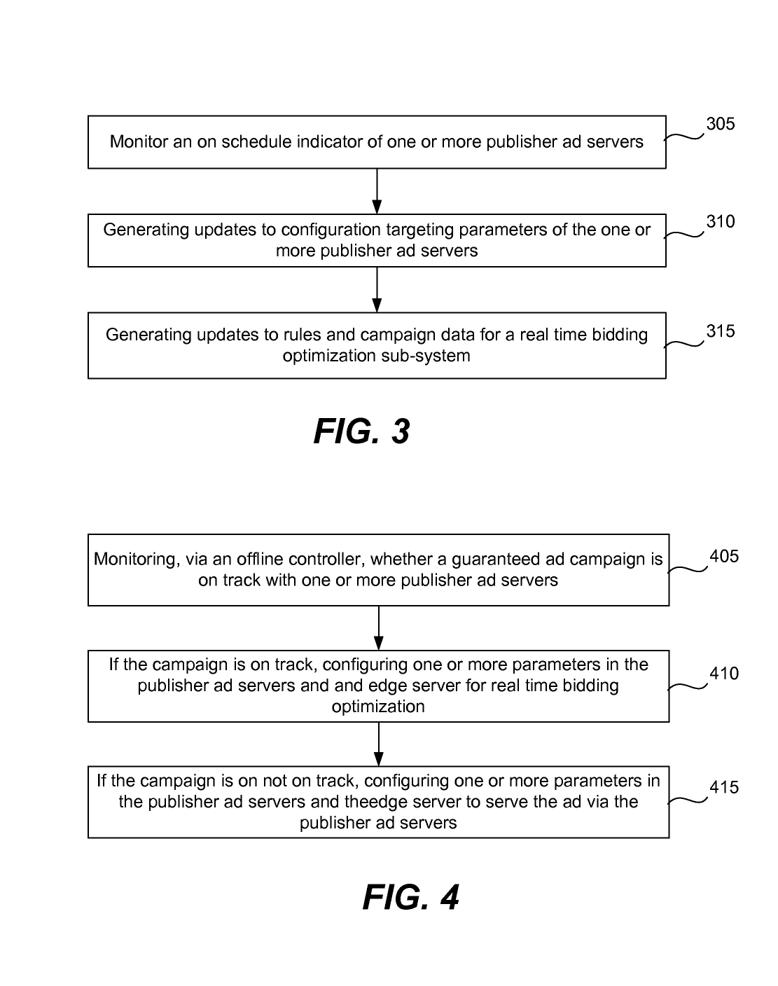

FIG. 3 illustrates an exemplary method for using a campaign controller in accordance with an embodiment of the present invention. In block 305, an on schedule indicator of one or more publisher ad server campaigns from the ad service. In block 310, updates are generated to configuration targeting parameters of the campaign in the publisher ad server. In block 315, updates are generated to rules and campaign data for an edge server to make a decision whether an impression should be sent to an ad server for real time bidding.

FIG. 4 illustrates an embodiment of a method. In block 405, the offline controller monitors whether the direct sold campaign is on track. If the ad campaign is on track, in block 410 it configures one or more parameters in the publisher ad server and the edge server for real time bidding optimization. However, if the direct sold campaign is not on track, it may configure one or more parameters in the publisher ad server and edge server to suppress real time bidding, as illustrated in block 415.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

We claim:

1. A method of holistically serving an ad to an ad segment on a Web page being viewed by a user by either of publisher ad server or real time bidding, the Web page published by a publisher, the method comprising:
monitoring, at a controller, the on-time schedule indicator (OSI) of a direct sold campaign in at least one guaranteed ad server;
generating, at a controller, updates to configuration targeting parameters of the ad campaign in the at least one guaranteed ad server; and
generating, at the controller, updates to rules and campaign data for an edge server to determined whether to send an impression to a unified optimization engine (UOE) for real time bidding based on the OSI.

2. The method of claim 1, wherein the controller uses an API to configure information in the at least one guaranteed ad server, including updating targeting parameters for the ad segment.

3. The method of claim 1, wherein the ad segment of the Web page is tagged with a optimization tag for a campaign.

4. The method of claim 3, wherein a write API command to the at least one guaranteed ad server and the optimization tag further determines parameters of the real time bidding.

5. The method of claim 1, wherein the direct sold campaign has a guaranteed number of impressions at a guaranteed price and the controller generates updates for UOE campaign to consider the ad segment for real time bidding.

6. The method of claim 1, wherein the controller configures geographic targeting of the UOE campaign based on the OSI of other applicable direct sold campaigns for that geo location.

7. The method of claim 1, wherein a direct sold campaign has a campaign name, number of impressions, budget, targeting parameters, geo, browser, OS, and device types.

8. The method of claim 1, wherein the controller is a separate server operating offline from the edge server and the at least one guaranteed ad server.

9. The method of claim 1, further comprising selecting a real time bidding floor to be at least equal or higher than the direct sold campaign.

10. The method of claim 1, wherein the offline controller pulls data from the at least one guaranteed ad server.

11. A method of holistically serving an ad to an ad segment on a Web page being viewed by a user by either of publisher ad server or real time bidding, the Web page published by a publisher, the method comprising:
monitoring, at an offline controller, a direct sold campaign in at least one publisher ad server, the direct sold campaign having a guaranteed price and a guaranteed number of impressions;
determining, at the offline controller, whether the direct sold campaign is on track to serve the guaranteed number of impressions; and
generating, at the offline controller, updates to configuration targeting parameters of the UOE ad campaign in the publisher ad server, wherein the controller updates targeting parameters for the ad segment based on whether the direct sold campaign is on track to control whether the ad is served from publisher ad server or real time bidding;
wherein the offline controller generates updates for an on-track UOE campaign to consider the ad segment for real time bidding.

12. The method of claim 11, further comprising generating, at the controller, updates to rules and campaign data for an edge server to determine whether to send an impression to an ad server for real time bidding.

13. The method of claim 12, wherein the ad segment of the Web page is tagged with a optimization tag for an ad campaign.

14. The method of claim 1, wherein the offline controller configures geographic targeting of the ad campaign based on an on schedule indicator of other direct sold campaigns in publisher ad server.

15. The method of claim 1, wherein the offline controller pulls data from the at least one publisher ad server.

16. A method of serving an ad to an ad segment on a Web page being viewed by a user to either real time bidding or to a guaranteed ad server system, said Web page published by a publisher, the method comprising:
receiving, at an offline server, data from one or more guaranteed ad servers indicative of whether or not a direct sold advertising campaign is on track for a publisher and along with campaign targeting information;
generating, by the offline server, updates to targeting parameters for the guaranteed ad servers for real time bidding campaign based on whether the direct sold advertising campaign is on track; and
generating, by the offline server, updates and rules to instruct an edge server to send impressions for real time bidding if the direct sold advertising campaign is on track.

17. A method for holistic ad serving in a network environment having individual users viewing one or more web pages published by a publisher, a publisher ad server network, an edge server, an ad server supporting real time bidding, the method comprising:
receiving impressions at an edge server from web pages published by a publisher, receiving, at the edge server, instructions from an offline server monitoring whether a direct sold campaign is on track; and
deciding, at the edge server, whether to submit the impression for real time bidding or to a publisher ad server.

18. A system for serving online ads by either of publisher ad server or real time bidding to a Web page published by a publisher, comprising:
a controller monitoring an on-time schedule indicator (OSI) of a direct sold campaign in at least one guaranteed ad server;
the controller, generating updates to configuration targeting parameters of the UOE ad campaign in the at least one guaranteed ad server and generating updates to rules and campaign data for an edge server to determined whether to send an impression to a unified optimization engine (UOE) for real time bidding based on the OSI.

19. The system of claim 18 in combination with an edge server and an ad server configured to support real time bidding.
